(19) United States
(12) Patent Application Publication
(10) Pub. No.: US 2008/0237929 A1
(43) Pub. Date: Oct. 2, 2008

(54) Systems and methods for tire construction

(76) Inventor: Hing Hung Sher, Hong Kong (CN)

Correspondence Address: MEYERTONS, HOOD, KIVLIN, KOWERT & GOETZEL, P.C., P.O. BOX 398, AUSTIN, TX, 78767-0398, US

(21) Appl. No.: 11/729,312

(22) Filed: Mar. 28, 2007

(51) Int. Cl. B29C 33/00

(52) U.S. Cl. 264/326

(57) ABSTRACT

In various embodiments, different sections of a tire may be preformed and bonded together. The preformed sections may include at least one fixing lug formed thereon. The preformed sections may be placed into a bonding mold where the preformed sections may be aligned in the bonding mold by aligning the fixing lugs on the preformed sections with corresponding features in the bonding molds. In some embodiments, bonding material may be placed on bonding areas between the preformed sections and the preformed sections may be placed in the bonding mold. In some embodiments, compressed air may be supplied through the air intake valve to the preformed sections in the bonding mold. Thermal energy may be applied to the preformed sections to form the tire.

### BACKGROUND

1. Field of the Invention

The present invention relates generally to tires and, more specifically, to systems and methods for tire construction.

2. Description of the Related Art

Tires are used for a variety of different vehicles. For example, tires may be used on cars, trucks, trailers, and construction equipment. Tires may also be used on toy vehicles (e.g., toy cars and trucks). It is desirable that tires on toy vehicles are functional but also are similar to tires on the corresponding real vehicles.

Tires for actual or toy vehicles may be made using the same types of manufacturing processes. For example, in one process, a tire may be prepared as a one-piece construction. Such tires may be formed using a hub with a surrounding mold to define the shape. One-piece construction tires may be solid or hollow (e.g., for pneumatic use). After molding, the tires may be removed from the hub and may be attached to a rim to form a wheel. Generally, one-piece tires may be difficult to manufacture due to difficulties in the formation and release of tires from an appropriate mold.

In other examples, a one-piece molded tire may be generally U-shaped and include two annular edges that are designed to couple to a rim. When the U-shaped tire is coupled to the rim, the resulting combination may form a substantially air-tight connection. Such a system, while generally reliable, may not be as preferred as an air-tight one-piece molded tire. Additionally, pneumatic tires may generally need some form of an air intake valve. Thus, it is desirable to have improved techniques for forming air-tight tires that are inexpensive and efficient.

### SUMMARY

In various embodiments, a method of forming a tire may include forming at least two preformed sections of the tire, placing the at least two preformed sections into a bonding mold (where the preformed sections at least partially contact each other in the bonding mold), placing bonding materials on the bonding areas and applying thermal energy to the bonding areas of the at least two preformed sections to bond the preformed sections together.

In various embodiments, a method of forming a tire may also include forming at least two preformed sections of the tire (where at least one of the preformed sections includes at least one fixing lug formed thereon and where preformed sections include an air-intake valve or a housing for an air-intake valve), fitting an elastic sleeve onto the valve and/or fitting a valve into the housing, placing the preformed sections into a bonding mold (e.g., where the at least one of the preformed sections may be aligned in the bonding mold by aligning the at least one fixing lug with at least one corresponding feature in the bonding mold), placing bonding material on bonding areas of the preformed sections, securing the bonding mold, applying compressed air through the air-intake valve into a cavity defined by the preformed sections disposed in the bonding mold, applying thermal energy to the bonding areas of the preformed sections in the bonding mold to form the tire, removing at least a portion of the air from the cavity, and unsecuring the bonding mold and removing the tire from the bonding mold. In some embodiments, thermal energy may be applied to the bonding areas instead of (or in addition to) placing bonding material on the bonding areas and then applying thermal energy (e.g., if the preformed sections are made of a thermoplastic material). In some embodiments, the bonding material may include one or more of uncured rubber pieces (e.g., for thermoset rubber), glue (e.g., for preformed sections made of thermoset rubber or thermoplastic materials), or an appropriate solvent to dissolve a thin layer of the bonding areas (e.g., for preformed sections made of thermoset rubber or thermoplastic materials). In some embodiments, thermal energy may be provided by a hot plate, a blow torch, etc. (e.g., to melt a thin layer of the bonding areas prior to bonding (e.g., for thermoplastics)). Other bonding materials and thermal energy sources are also contemplated.

### BRIEF DESCRIPTION OF THE DRAWINGS

A better understanding of the present invention may be obtained when the following detailed description is considered in conjunction with the following drawings, in which:

FIG. 1 illustrates an embodiment of a tire.

FIGS. 2a-c illustrate various mold types for forming a preformed section, according to various embodiments.

FIGS. 3a-c illustrate preformed sections with fixing lugs, according to an embodiment.

FIGS. 4a-h illustrate bonding areas on the preformed sections and air intake valves, according to an embodiment.

FIG. 5 illustrates two bonding molds, according to an embodiment.

FIG. 6 illustrates two bonding molds closed together, according to an embodiment.

FIGS. 7a-b illustrates another view of two bonding molds, according to an embodiment.

FIG. 8 illustrates two bonding molds that have been separated, according to an embodiment.

FIGS. 9a-c illustrate a tire removed from the bonding molds, according to an embodiment.

FIG. 10 illustrates a method for forming the tire with a thermoset rubber, according to an embodiment.

FIG. 11 illustrates a method for forming the tire with a thermoplastic, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

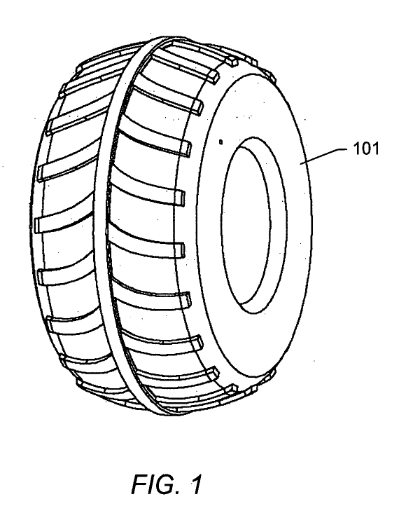

FIG. 1 illustrates an embodiment of a tire. In some embodiments, tire 101 may be used in several applications. For example, tire 101 may be used on cars, trucks and trailers. Tire 101 may also be used on toy cars, toy trucks, and toy trailers. Other uses of tire 101 are also contemplated. Tire 101 may have a hollow core that may be pressurized (e.g., with air). In some embodiments, tire 101 may be solid. The outer surface of tire 101 may be smooth or may have an outer tire tread (as shown in FIG. 1). Other configurations of tire 101 are also contemplated. Tire 101 may be torus-shaped or oblate spheroid shaped. Other shapes are also contemplated. Tire 101 may be used with or without a hub.

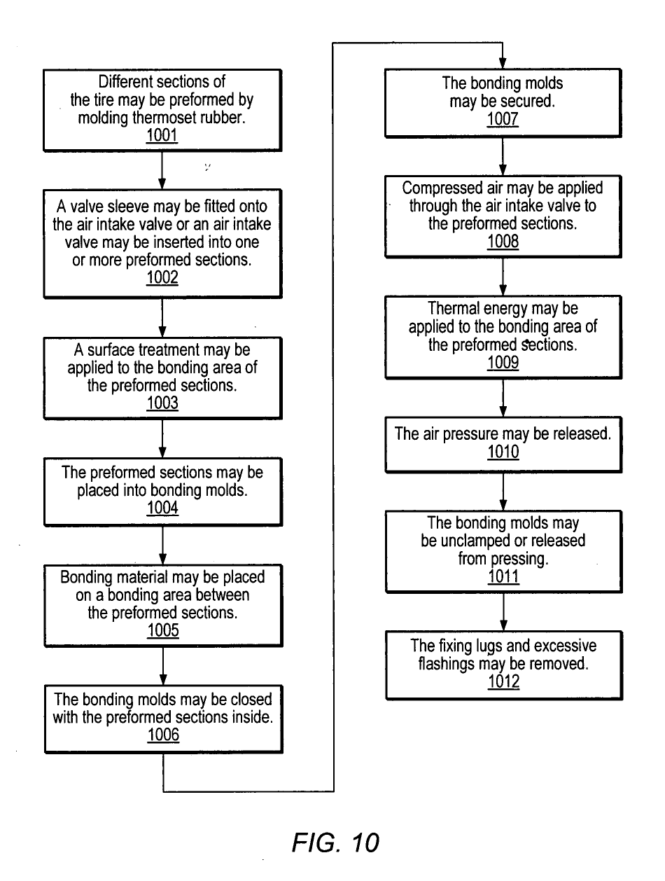

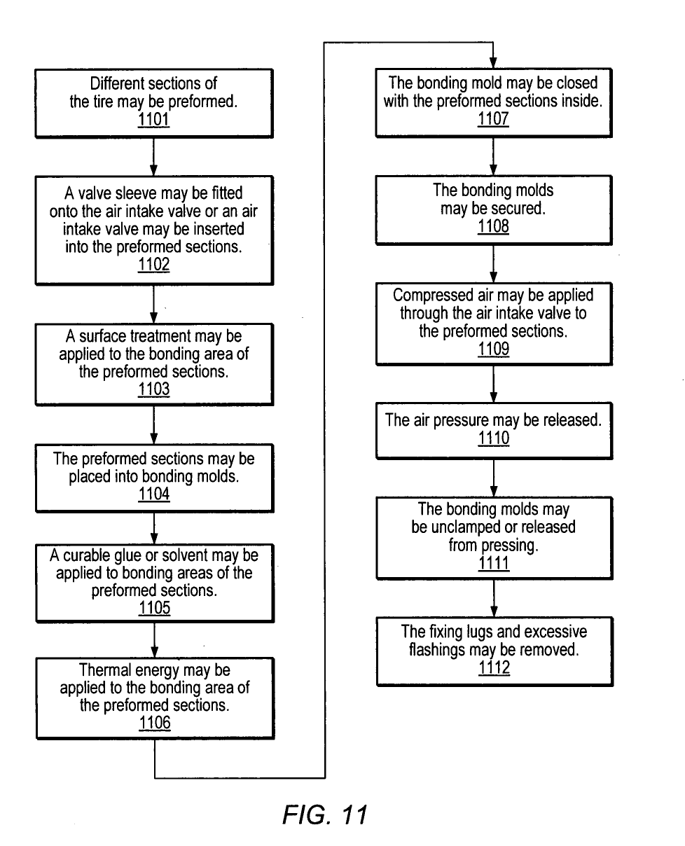

In some embodiments, tire 101 may be made of a thermoset rubber (e.g., see the method of FIG. 10) or a thermoplastic material (e.g., see the method of FIG. 11). In some embodiments, the material used for the tire 101 may be flexible (e.g., capable of allowing the tire 101 to be inflated). Other materials may also be used. In some embodiments, tire 101 may be made of two or more preformed sections. In some embodiments, each of two preformed sections may represent approximately 50% of a full tire formed from the preformed sections. As another example, one preformed section may be approximately 30% and one preformed section may be approximately 70% of the full tire mold. In some embodiments, three or more preformed sections may be used (e.g., three sections with each of the three sections representing approximately 33% of the full tire). Other numbers and ratios are also contemplated. In some embodiments, the preformed sections may be symmetric (e.g., reflection symmetric) or asymmetric.

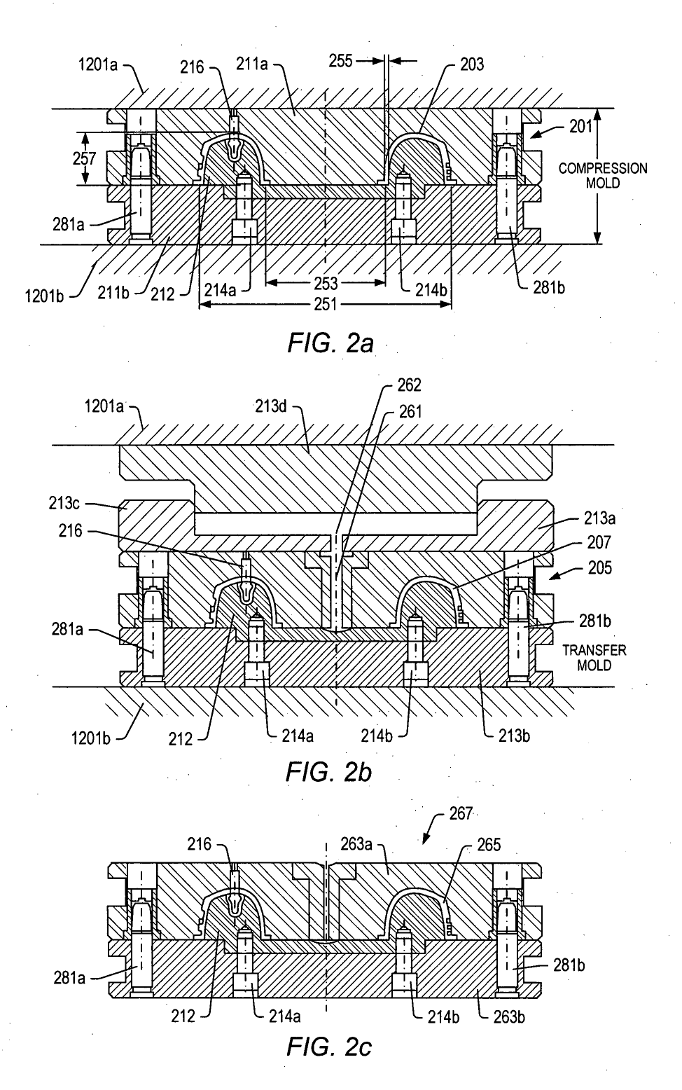

In some embodiments, the preformed sections may be compression molded, for example, with the compression mold shown in FIG. 2a. In some embodiments, the preformed sections may be transfer molded, for example with the transfer mold shown in FIG. 2b. As seen in FIG. 2c, preformed sections may also be injection molded (e.g., using a thermoplastic), using an injection mold shown in FIG. 2c. Other molding processes are also possible (e.g., extrusion molding, blow molding, rotational molding, thermoforming, and reaction injection molding). Further details regarding molding processes may be found in the following U.S. patents, all of which are incorporated herein by reference: U.S. Pat. No. 3,472,715 to Weinbrenner et al; U.S. Pat. No. 4,043,603 to Bergmann et al.; U.S. Pat. No. 4,140,165 to Lapeyre; 4,201,744 to Makinson; and U.S. Pat. No. 5,015,315 to Nakasaki.

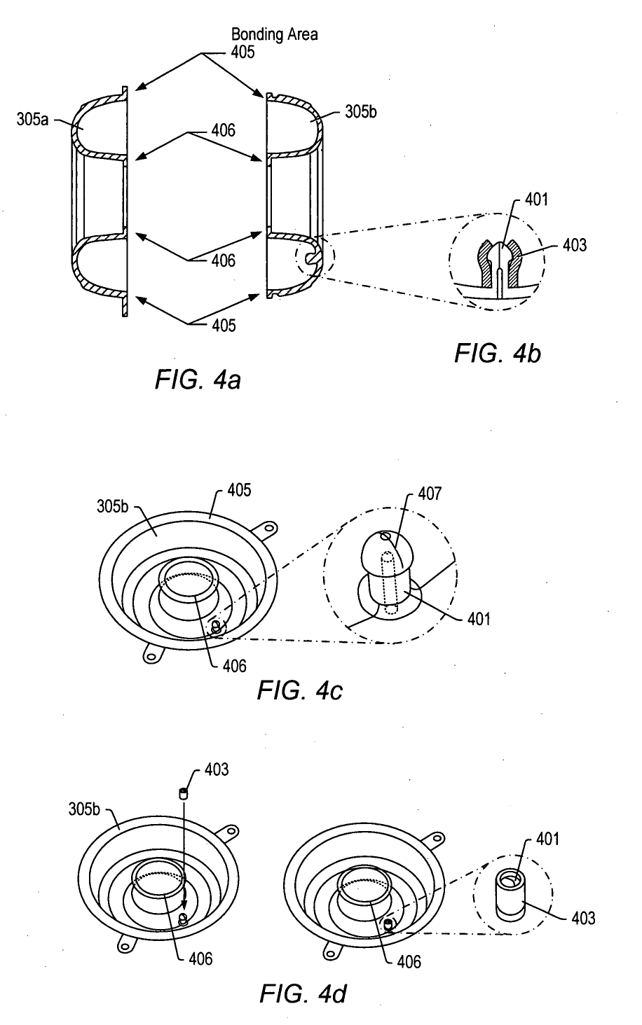

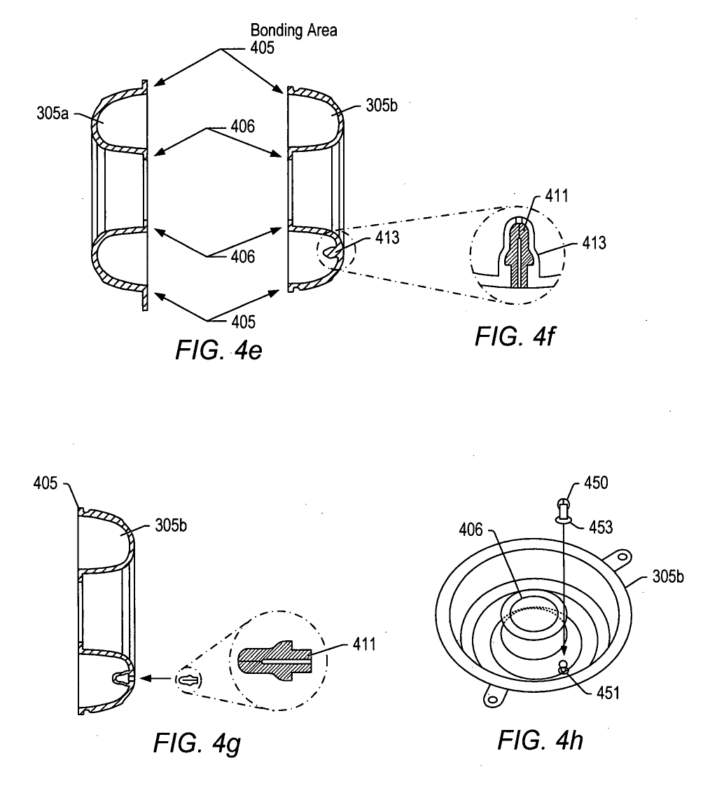

In some embodiments, different sections of a tire may be formed by molding thermoset rubber into preformed sections 305a,b (e.g., see FIG. 4a). For example, two sections of tire 101 may be formed by compression molding thermoset rubber pieces in a compression mold 201 (as seen in FIG. 2a). Thermoset rubber pieces (e.g., uncured thermoset rubber pieces) may be placed in mold cavities (e.g., mold cavity 203) of the compression mold 201 and heat and pressure may be applied to the thermoset rubber pieces. For example, for a preformed section 305a with dimensions of approximately:

outer diameter 251 approximately in a range of 100 mm-150 mm,

inner diameter 253 approximately in a range of 30 mm-50 mm

width 257 approximately in a range of 30-50 mm (for a full tire width approximately in a range of 60 mm-100 mm), and

wall thickness 255 approximately in a range of 2 mm-5 mm, a force approximately in a range of 50-100 tons may be applied to the compression mold halves 211a,b (e.g., through compression machine hot plates 1201a,b) for a time approximately in a range of 90 to 180 seconds to mold the thermoset rubber into a preformed section 305a (e.g., in mold cavity 203). In some embodiments, pins 281a,b may be guide pins for the compression mold halves 211a,b to assist in fitting the halves 211a,b together in a matching position. The mold material may be heated to a temperature approximately in a range of 130 to 180 degrees Celsius. Other forces, times, and temperatures may be used (which may be dependent on the type of material used and/or the dimensions of the preformed section 305a,b in the compression mold 201). For example, preformed sections 305a,b with a greater wall thickness may require a higher temperature and/or a longer time to form the preformed sections 305a,b in the compression mold 201. In some embodiments, other materials may be used in the compression mold 201 (e.g., a thermoplastic).

In some embodiments, a core 212 may be fitted onto the compression molding half 211b to shape the preformed sections 305a,b. For example, the core 212 may be coupled to compression molding half 211b by fixing bolts 214a,b. In some embodiments, the core 212 may be interchangeable with other mold components (such as differently shaped cores) for different shapes of tires. In some embodiments, the core 212 may not be a separate component from the compression mold half 211b, but may be an integral part of compression mold half 211b.

In some embodiments, the mold halves (e.g., compression mold halves 211a,b and transfer mold halves 213a,b) may have shapes inverted from the desired preformed section shape. The mold halves may be steel plates that may be constructed by cutting the inverted shape into the steel plates. Other materials may also be used to make the molding halves. Other ways of forming the mold halves are also possible. For example, the mold halves may be cast molded.

In some embodiments, a compound other than uncured rubber pieces may be used in the preformed molding process. Compound formulations may be developed by experimenting with different compositions of raw materials to find a compound suitable for particular molds. For example, different types of rubber may be better suited for thicker tires. As another example, a different type of rubber may cure faster for a faster production process. A formula may be developed that details the quantities of the materials used in the compound. The formula may be used to prepare batches of the compound for use in the molds. For example, the materials may be mixed together (e.g., in quantities defined by the determined formula) using mixing machines. The initial mixed compounds may be in loaf-sized pieces for use in the molding process.

In some embodiments, the thermoset rubber may be transfer molded in transfer mold 205 (e.g., see FIG. 2b). Transfer mold 205 may have some similar components (e.g., components 281a-b, 212, and 214a-b) as compression mold 201, but transfer mold 205 may have a different configuration in order to transfer mold the thermoset rubber. For example, the thermoset rubber may be placed onto a sprue opening 262 and then pushed (e.g., by a mold plate 213d with force from compression machine hot plates 1201a,b) through the transfer sprue 261 into mold cavities 207 between mold halves 213a,b to cure. A similar force, temperature, and time may be used on the thermoset rubber in the transfer mold 205 as in the compression mold 201. In some embodiments, different forces, temperatures, and times may be used.

In some embodiments, the preformed sections 305a,b may be injection molded (e.g., see FIG. 2c). Injection mold 267 may have some similar components (e.g., components 281a-b, 212, and 214a-b) as compression mold 201, but injection mold 267 may have a different configuration in order to perform an injection molding process on a thermoplastic material. For example, a thermoplastic material may be fed into a barrel for a mold to preheat the thermoplastic material. The preheated thermoplastic may be injected into mold cavity 265 through a sprue 269 to cure in the mold cavity 265. The mold cavity 265 may be formed between mold halves 263a,b. In some embodiments, a core 212 may also be used. In some embodiments, a thermoset rubber may be injection molded to form a tire. Alternatively, different components that form a thermoset rubber when combined may be injected together into the injection mold 267 to cure.

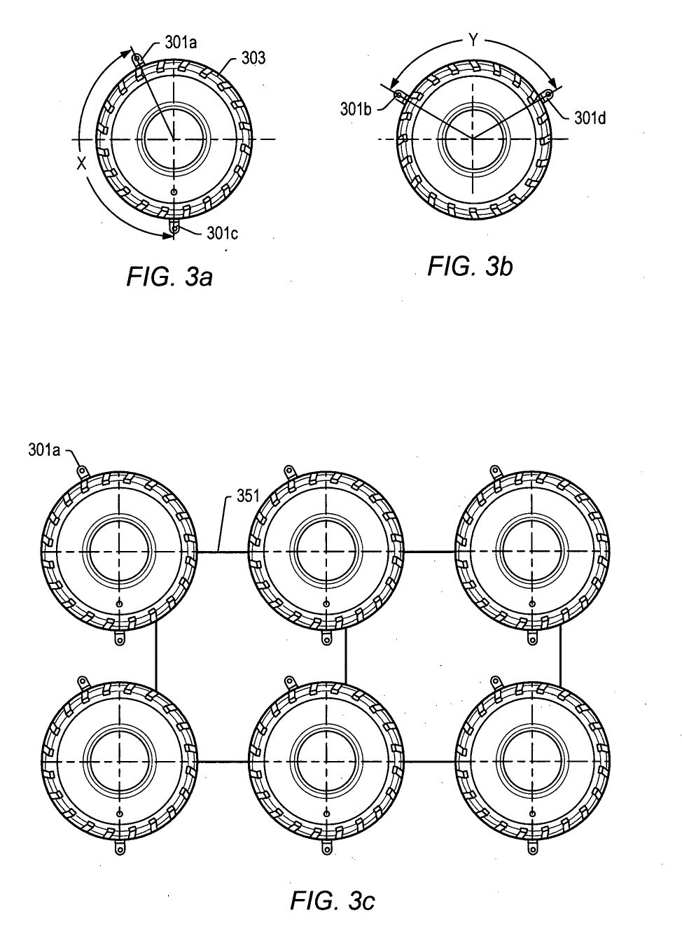

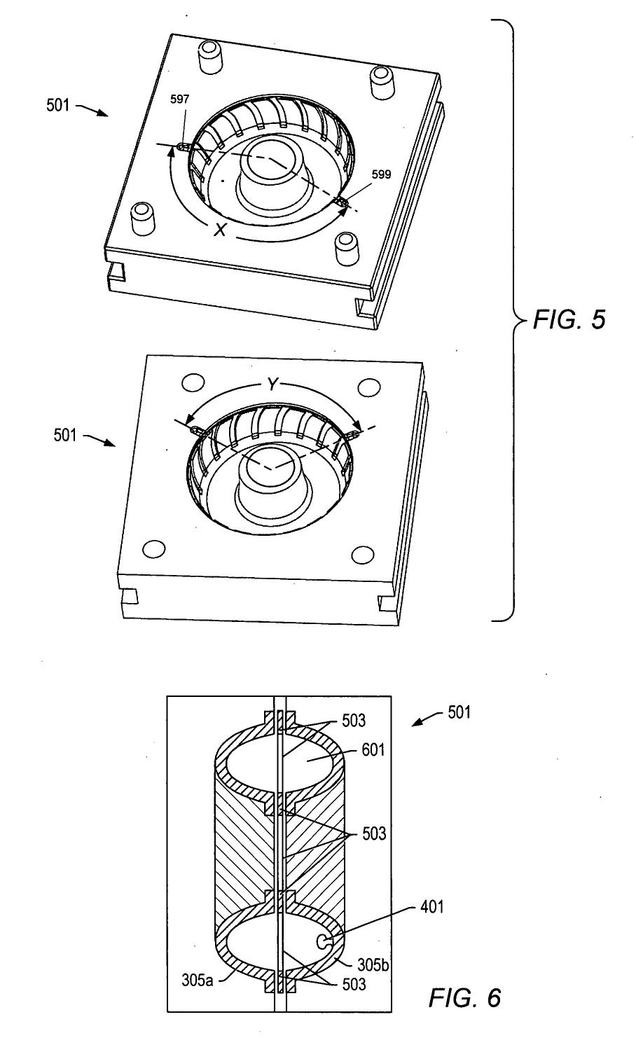

As seen in FIGS. 3a-b, in some embodiments, the preformed sections (e.g., preformed sections 305a, 305b) may include fixing lugs (e.g., fixing lugs 301a-d). Fixing lugs may be formed to facilitate alignment of the preformed sections 305a,b in a latter bonding process. For example, fixing lugs may be molded in a certain place on the preformed sections 305a,b with respect to a thread pattern 303 on the preformed section. Fixing lugs 301a-d may include protrusions, slots, or other features that may be used to match a mating feature in a bonding mold. For example, fixing lugs 301a,c on the left preformed section 305a (see FIG. 3a) may be placed at different points on the preformed section 305a than fixing lugs 301b,d on the right preformed section 305b (see FIG. 3b). Fixing lugs 301a,c may be used to align the left preformed section 305a with complementary features on a left side of bonding mold 501 (FIG. 5) and right preformed section 305b may be aligned with complementary features on a right side of the bonding mold 501. The aligned preformed sections 305a,b may then have corresponding aligned tire threads when the preformed sections 305a,b are bonded in the bonding mold 501. Fixing lugs 301a-d may be placed on the preformed sections 305a,b at locations such that the preformed sections 305a,b may only be loaded into the proper bonding mold 501 (e.g., if the preformed section is not loaded into the proper mold, the fixing lug will not match up with a complementary feature on the mold).

In some embodiments, forming the preformed sections 305a,b may include forming an air intake valve 401 (e.g., see FIGS. 4a-d). For example, the compression mold 201, transfer mold 205, and injection mold 267 may have an inverted air intake valve shape 216 (see FIGS. 2a-c). The air intake valve shape 216 may form the air intake valve 401 in the preformed sections 305a,b during the molding process. The air intake valve 401 may be formed with a split 407 to receive a fluid (e.g., air), as shown in FIG. 4c. In some embodiments, the air intake valve 401 may be formed in one preformed section. In some embodiments, an air intake valve 450 may be inserted into one or more of the preformed sections 305a,b through a preformed hole 451 in a preformed section 305b that has a smaller diameter than a diameter of a base 453 of the air intake valve 450 to be inserted (see FIG. 4h). In some embodiments, the air intake valve 450 may be secured inside the preformed hole 451 through an adhesive. In some embodiments, the air intake valve 450 may include a flap as part of the base 453 on the portion of the air intake valve 450 being inserted into the preformed hole 451. Adhesive may be applied to the base 453 prior to inserting the air intake valve 450 into the preformed hole 451 and the adhesive may hold the air intake valve 450 in the preformed hole 451. The base 453 may also form a further seal against air leakage when the flap is pressed against the inside of the tire 101 during inflation.

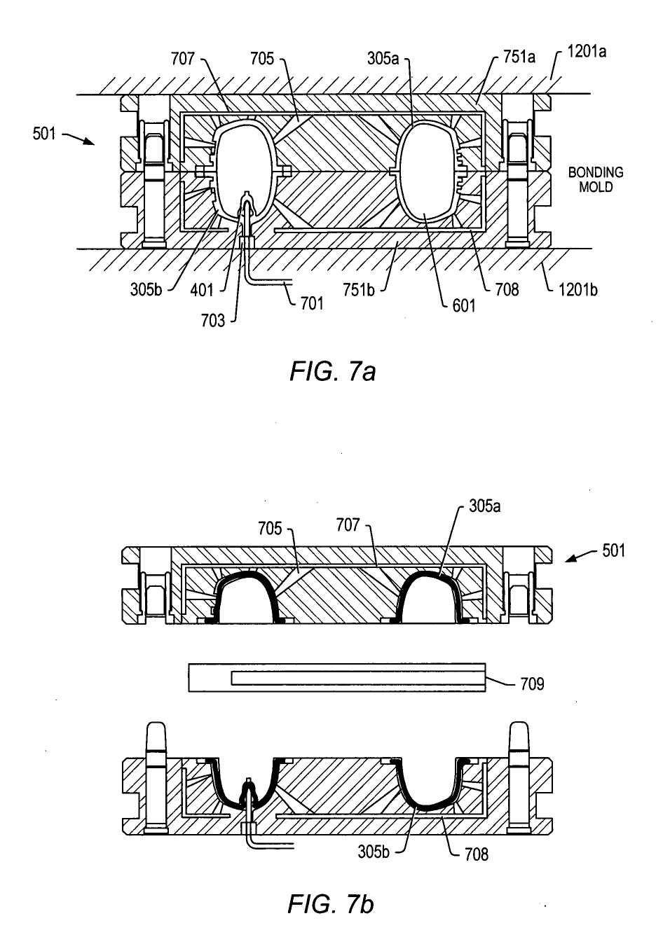

In some embodiments, a valve sleeve 403 may be inserted on the air intake valve 401 to apply compression to the air intake valve 401 to bias the air intake valve 401 into a closed position. Valve sleeve 403 may be stretched when an air nozzle 703 (e.g., see FIGS. 7a-b) engages the air intake valve 401 (e.g., is inserted between the split portion 407 of the air intake valve 401). In some embodiments, the valve sleeve 403 may be formed by compression molding hot cured rubber formulated to have sufficient strength to keep the air intake valve 401 closed to inhibit air from leaking when the tire is pressurized. In some embodiments, valve sleeve 403 may be formed by extruding a tube and cutting the extruded tube into individual valve sleeves 403. Other ways of making valve sleeves 403 are also contemplated. Valve sleeve 403 may be slid onto the air intake valve 401 (e.g., manually by a person or automatically by a machine).

In some embodiments, forming the preformed sections 305a,b may include forming a housing 413 (e.g., see FIGS. 4e-g). For example, compression mold 201, transfer mold 205, and injection mold 267 may have an inverted housing shape 216. The housing shape 216 may form the housing 413 in the preformed sections 305a,b during the molding process. The housing 413 may have sufficient strength to keep the air intake valve 411 closed to prevent air from leaking when the tire is pressurized.

In some embodiments, an air intake valve 411 may be inserted into housing 413. Air intake valve 411 may be formed with a split 417 to receive a fluid (e.g., air). Housing 413 may apply compression to air intake valve 411 to bias the air intake valve 411 closed. Housing 413 may be stretched when an air nozzle 703 (e.g., see FIG. 7a) engages air intake valve 411 (e.g., is inserted between the split portion of the air intake valve). In some embodiments, air intake valve 411 may be formed by more than one piece. In some embodiments, air intake valve 411 may be formed by compression molding hot cured rubber. Other materials such as thermoplastics and other ways of making air intake valve 411 are also contemplated. Air intake valve 411 may be inserted into housing 413 (e.g., manually by a person or automatically by a machine).

As seen in FIG. 3c, in some embodiments, several preformed sections 305a,b may be formed together, for example, in a single mold. For example, several preformed sections 305a,b may be connected through connectors 351 formed in the molds during the formation of the preformed sections 305a,b. This may result in a row or grid of preformed sections 305a,b that may be separated by snapping or cutting the connectors 351 between the preformed sections 305a,b. Any other way of breaking and/or removing the connectors from between the preformed sections 305a,b without damaging the preformed sections 305a,b may be used to separate the sections. In some embodiments, several separate preformed sections 305a,b (e.g., different halves) may be formed at the same time in molds with separate individual cavities which may be coupled to each other by one or more connectors. Connectors may include preformed connectors that are placed in contact with the molds or molded connectors that are made during the molding process of the preformed sections 305a,b.

In some embodiments, the preformed sections 305a,b may be coupled together in a bonding mold to form a tire by melting or curing the preformed sections 305a,b together. In some embodiments, the preformed sections 305a,b may be made of a thermoset rubber and may be bonded together using uncured rubber and/or adhesive between the preformed sections 305a,b. In another embodiment, preformed sections 305a,b may be made of a thermoplastic material and may be bonded together using uncured thermoplastic and/or adhesive between the preformed sections 305a,b. In some embodiments, the preformed sections 305a,b may be made of thermoplastic and may be bonded together by melting bonding surfaces (e.g., bonding areas 405 and 406) between the preformed thermoplastic sections using heat sources (e.g. a hot plate 709, as shown in FIG. 7b) or by using a solvent (this may also be done with thermoset rubber preformed sections 305a,b). Other methods may also be used for bonding the preformed sections 305a,b together. Other configurations of bonding areas 405 and 406 are also contemplated.

In some embodiments, the preformed sections 305a,b may be coupled together while under internal pressure from a fluid inserted between the preformed sections 305a,b during the bonding process. This may maintain a predetermined shape for the tire during the bonding process. In some embodiments, the fluid may be inserted through the air intake valve formed in one of the preformed sections 305a,b. In some embodiments, the internal pressure may be released after the bonding process. After the preformed sections 305a,b are bonded together, the formed tire may be removed from the bonding molds.

FIG. 10 illustrates a flow chart of a method for forming a tire 101 from thermoset rubber (e.g., natural rubber) preformed sections 305a,b. It should be noted that in various embodiments of the methods described below, one or more of the elements described may be performed concurrently, in a different order than shown, or may be omitted entirely. Other additional elements may also be performed as desired. Portions or all of the process described below may be conducted manually or automatically (e.g., by an assembly line controlled by a controller and memory medium).

At 1001, preformed sections 305a,b of a tire 101 may be formed by molding a thermoset material into the preformed sections 305a,b. For example, a compression mold (as shown in FIG. 2a) or a transfer mold (as shown in FIG. 2b) may be used to form the preformed sections 305a,b using a thermoset material. In other embodiments, an injection mold (as shown in FIG. 2c) may be used to form preformed sections 305a,b using a thermoset material. The thermoset material may be a thermoset rubber. Other thermoset materials may also be used. In some embodiments, the preformed sections 305a,b may include an air intake valve or a housing to receive an air intake valve. In some embodiments, the preformed sections 305a,b may include fixing lugs.

At 1002, a valve sleeve may be fitted (e.g., slid) onto an air intake valve or an air intake valve 411 may be inserted into one or more preformed sections 305a,b (as shown in FIG. 4g) depending on the configuration of the valve structure for the preformed sections 305a,b. For example, as shown in FIG. 4d, a valve sleeve 403 may be fitted onto one or more portions of the air intake valve 401 preformed into the preformed sections 305a,b. In some embodiments, valve sleeves 403 may be slid onto air intake valves 401 to bias the air intake valves 401 closed. In some embodiments, as shown in FIG. 4g, air intake valves 411 may be inserted into housings 413. In some embodiments, an air intake valve 450 may be inserted into one or more of the preformed sections 305a,b (e.g., through a preformed hole 451 in a preformed section that has a smaller diameter than a diameter of a base 453 of the air intake valve 450 to be inserted). The base 453 of the air intake valve 450 may further include a flap and/or may be secured in the tire with adhesive. In some embodiments, the air intake valve 450 may be snapped onto the preformed section, as depicted in FIG. 4h. In some embodiments, the air intake valve 450 may have a valve sleeve 403 coupled to it prior to being coupled to the preformed section.

At 1003, a surface treatment may be applied to the bonding areas 405 and 406 of the preformed sections 305a,b (e.g., see FIGS. 4a and 4c). Bonding areas may include mating surfaces on the preformed sections 305a,b that are designed to engage corresponding bonding areas on other preformed sections 305a,b (e.g., when closed together in a bonding mold). The surface treatment may include treating the bonding areas (e.g., bonding areas 405 and 406) of the preformed sections 305a,b with a solvent to remove grease, remove dust, and/or act as a release agent. The surface treatment may thus increase bonding strength between the preformed sections 305a,b by removing impurities that may reduce the bond strength.

At 1004, the preformed sections 305a,b may be placed into a bonding mold 501 (e.g., see FIGS. 5-7b). Placing preformed sections 305a,b into the bonding mold 501 may include aligning the fixing lugs (e.g., fixing lugs 301a,c) with corresponding features (e.g., features 597,599) in the bonding mold 501. In some embodiments, instead of aligning fixing lugs, other features of the preformed sections 305a,b may be aligned in the bonding mold 501. For example, tire treads on the preformed sections 305a,b may be aligned with complementary preformed tire tread patterns on a surface of the bonding mold 501.

At 1005, a bonding material 503 (e.g., a thermoset rubber such as uncured rubber pieces (such as strips) and/or an adhesive (such as curable glue)) may be placed on the bonding areas (e.g., bonding areas 405 and 406) between the preformed sections 305a,b (as shown in FIG. 6). In some embodiments, a bonding material may not be used. In some embodiments, glue (e.g., curable glue) may be applied as bonding material 503. In some embodiments, curable glue may be used in addition to bonding material 503. In other embodiments, a solvent may be used as a bonding material. For example, a solvent may be used to at least partially dissolve the thermoset rubber of the bonding areas 405 and 406 of one or both of the preformed sections 305a,b. The preformed sections 305a,b may then bond when the dissolved thermoset rubber between the two bonding areas 405 and 406 mix and re-solidify. Suitable solvents of dissolving a thermoset rubber may include hydrocarbon solvents including, but not limited to, hexanes, heptanes, octanes, benzene, toluene, xylenes, and hydrocarbon mixtures including, but not limited to kerosene, gasoline, naphtha, and diesel hydrocarbon mixtures.

At 1006, the bonding mold 501 may be closed with the preformed sections 305a,b inside (e.g., see FIG. 7). In some embodiments, a vacuum may be applied to the preformed sections 305a,b to hold the preformed sections 305a,b in the bonding mold 501. Vacuum conduits 707,708 may allow a vacuum to be formed in the bonding mold's vacuum chambers (e.g., vacuum chamber 705) to hold the preformed sections 305a,b to the bonding mold 501.

At 1007, the bonding mold 501 may be secured (e.g., clamped or pressed together). In some embodiments, the bonding mold 501 may be pressed together by a compression molding machine (e.g., see FIG. 7a). For example, plates 1201a,b of the compression molding machine may engage to hold the two halves 751a,b of the bonding mold 501 together. In some embodiments, the bonding mold 501 may be clamped closed. The clamps may pull the two halves 751a,b together, for example, using internal threads or hydraulics. Other clamping methods are also contemplated.

At 1008, compressed air 701 (or another fluid) may be applied through the air intake valve 401, 411 or 450 to the preformed sections 305a,b in the bonding mold 501. For example, compressed air 701 may be applied through the air nozzle 703 to the air intake valve 401, 411 or 450 in a preformed section 305b to fill a cavity 601 formed between the preformed sections 305a,b. As the air nozzle 703 is inserted into the air intake valve 401, 411 or 450 and/or engages the air intake valve 401, 411 or 450, a valve sleeve 403 or a housing 413 on the air intake valve 401 (e.g., see valve sleeve 403 in FIG. 4b and/or housing 413 in FIG. 4f) may expand to allow the air intake valve 401, 411 or 450 to expand and open. The compressed air 701 may provide internal pressure to keep the preformed sections 305a,b shaped while in the bonding mold 501.

At 1009, thermal energy may be applied to the bonding areas 405 and 406 of the preformed sections 305a,b in the bonding mold 501. In some embodiments, thermal energy may be applied to the preformed sections 305a,b. In some embodiments, for thermoset rubber, thermal energy may be applied to the bonding areas 405 and 406 of the preformed sections 305a,b after the bonding molds 501 are closed. Applying thermal energy to the preformed sections 305a,b may include applying thermal energy to the bonding material 503 (e.g., by heating the mold with electric or gas heating elements). In some embodiments, infrared or microwave radiation may be used to apply thermal energy. In some embodiments, an open flame (e.g., from a blowtorch) may be used to apply thermal energy. A bonding temperature approximately in a range of 120 to 180 degrees Celsius may be maintained at the bonding areas 405 and 406 inside the bonding mold 501 for a time approximately in a range of 90 to 180 seconds. Other temperatures and times may also be used. The times and temperatures may be dependent on the type of thermoset rubber used in the preformed sections 305a,b and/or the type of bonding material 503 used to bind the two preformed sections 305a,b. The times and temperatures may also depend on other properties (e.g., thickness of preformed sections 305a,b, etc.).

At 1010, if the tire was at least partially inflated with air, the air pressure may be released (e.g., after the preformed sections 305a,b are securely bonded). The air pressure may be released after the tire 101 has cooled (and, for example, the bonding material is secured). In some embodiments, the air pressure may be released after the thermal energy has been applied, but before the tire 101 has cooled. In some embodiments, the air pressure may be released as the thermal energy is being applied.

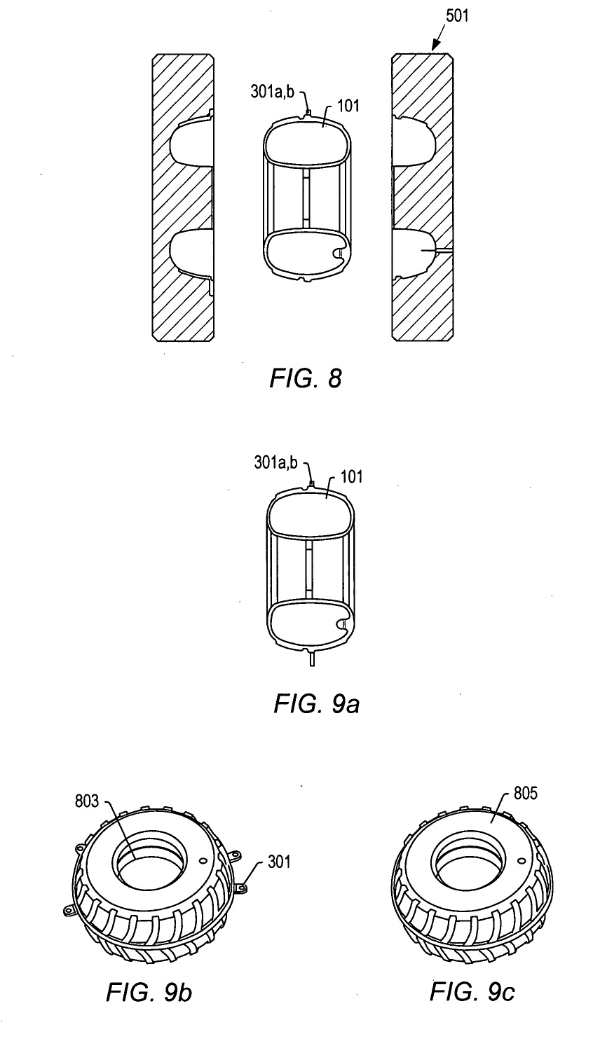

At 1011, bonding molds 501 may be separated (e.g., may be unclamped or released from pressing) and the formed tire 101 may be removed from the mold (e.g., see FIG. 8). In some embodiments, tire 101 may have an outer diameter approximately in a range of 100 mm-150 mm, an inner diameter approximately in a range of 30 mm-50 mm, a width approximately in a range of 60 mm-100 mm, and a thickness approximately in a range of 2 mm-5 mm. Other sizes are also possible. For example, FIG. 9a illustrates a cross section of tire 101 removed from the bonding mold 501.

At 1012, the fixing lugs 301 and, for example, excessive flashings of the tire (if any) may be removed from the tire. For example, fixing lugs and excessive flashings may be removed by a razor. FIG. 9b illustrates an embodiment of a tire 803 prior to the fixing lugs 301 being removed. FIG. 9c illustrates an embodiment of the tire 805 with fixing lugs removed.

FIG. 11 illustrates a method for forming a tire. It should be noted that in various embodiments of the methods described below, one or more of the elements described may be performed concurrently, in a different order than shown, or may be omitted entirely. Other additional elements may also be performed as desired. Portions or all of the process described below may be conducted manually or automatically (e.g., by an assembly line controlled by a controller and memory medium).

At 1101, preformed sections 305a,b of the tire 101 may be formed by molding a thermoplastic material. In some embodiments, the preformed sections 305a,b may include an air intake valve or a housing to receive an air intake valve. In some embodiments, the preformed sections 305a,b may include fixing lugs. The preformed sections 305a,b may be made by injection molding a thermoplastic material. Thermoplastic materials that may be used include, but are not limited to styrene-butadiene-styrene (SBS), polystyrene, acrylonitrile butadiene styrene (ABS), nylon, polypropylene, polyethylene, thermoplastic urethane (TPU), or polyvinyl chloride (PVC). Other manufacturing processes are also possible to form the preformed sections 305a,b. In some embodiments, injection molding may include injecting (under pressure) a selected thermoplastic resin into a clamped mold. The thermoplastic resin material may be selected based on the desired properties of the tire (e.g., overall size, feature size, etc.). The injection mold may have a shape that is the inverse of the desired preformed section shape. The selected thermoplastic resin may be inserted through a sprue (which may include a nozzle and a barrel) at a temperature, for example, sufficient to allow injection of the thermoplastic resin into the mold. The temperature and pressure of the injection molding will depend on the selected thermoplastic resin, but generally is approximately in a range of 130 degrees Celsius to 190 degrees Celsius. The injection mold may remain clamped until the thermoplastic resin cools and can maintain a constant shape apart from the injection mold. Generally, the injection mold may remain sealed for at least 20 seconds. The time needed for maintaining the injection mold 267 in a sealed position may depend on several variables including the type of thermoplastic resin and the temperature of the injected thermoplastic resin (among others). The preformed sections 305a,b may be cooled (e.g., with water channels surrounding the mold). The injection mold may then be unclamped and the preformed sections 305a,b removed. In some embodiments, ejector pins in the injection mold may be used to push the preformed sections 305a,b out of the injection mold.

At 1102, a valve sleeve may be fitted (e.g., slid) onto an air intake valve or an air intake valve 411 may be inserted into one or more preformed sections 305a,b (as shown in FIG. 4g) depending on the configuration of the valve structure for the preformed sections 305a,b. For example, as shown in FIG. 4d, a valve sleeve 403 may be fitted onto one or more portions of the air intake valve 401 preformed into the preformed sections 305a,b. In some embodiments, valve sleeves 403 may be slid onto air intake valves 401 to bias the air intake valves 401 closed. In some embodiments, as shown in FIG. 4g, air intake valves 411 may be inserted into housings 413. In some embodiments, an air intake valve 450 may be inserted into one or more of the preformed sections 305a,b (e.g., through a preformed hole 451 in a preformed section that has a smaller diameter than a diameter of a base 453 of the air intake valve 450 to be inserted). The base 453 of the air intake valve 450 may further include a flap and/or may be secured in the tire with adhesive. In some embodiments, the air intake valve 450 may be snapped onto the preformed section, as depicted in FIG. 4h. In some embodiments, the air intake valve 450 may have a valve sleeve 403 coupled to it prior to being coupled to the preformed section.

At 1103, a surface treatment may be applied to the bonding areas 405 and 406 of the preformed sections 305a,b (e.g., see FIGS. 4a and 4c). Bonding areas 405 and 406 may include mating surfaces on the preformed sections 305a,b that are designed to engage corresponding bonding areas 405 and 406 on other preformed sections 305a,b (e.g., when closed together in a bonding mold 501). The surface treatment may include treating the bonding areas 405 and 406 of the preformed sections 305a,b with a solvent to remove grease, remove dust, and/or act as a release agent. The surface treatment may thus increase bonding strength between the preformed sections 305a,b by removing impurities that may reduce the bond strength.

At 1104, the preformed sections 305a,b may be placed into a bonding mold 501 (e.g., see FIGS. 5-7b). Placing preformed sections 305a,b into the bonding mold 501 may include aligning the fixing lugs (e.g., fixing lugs 301a,c) with corresponding features (e.g., features 597,599) in the bonding mold 501. In some embodiments, instead of aligning fixing lugs, other features of the preformed sections 305a,b may be aligned in the bonding mold 501. For example, tire treads on the preformed sections 305a,b may be aligned with complementary preformed tire tread patterns on a surface of the bonding mold 501.

At 1105, a curable glue or solvent may be applied to the preformed sections 305a,b (in some embodiments, a curable glue or solvent may not be used). In some embodiments, a curable glue or solvent may be applied to the bonding areas 405 and 406 of the preformed sections 305a,b. In some embodiments, toluene or gasoline may be used between the preformed sections 305a,b as an adhesive or solvent for preformed sections 305a,b. For example, this solvent or other suitable solvents may be capable of at least partially dissolving the thermoplastic and may be placed on the bonding areas 405 and 406 of one or both of the preformed sections 305a,b. The bonding areas 405 and 406 of the preformed sections 305a,b may then re-solidify after intermixing with thermoplastic from the other respective preformed section when the bonding mold 501 is closed. In some embodiments, the preformed sections 305a,b may be bonded together by melting bonding surfaces 405 and 406 between the preformed sections 305a,b using heat sources (e.g. a hot plate 709 as shown in FIG. 7b).

At 1106, thermal energy may be applied to the bonding areas 405 and 406 of the preformed sections 305a,b. In some embodiments, for thermoplastic tires, thermal energy may be applied to the bonding area of the preformed sections 305a,b before the bonding mold 501 is closed. In some embodiments, applying thermal energy to the bonding areas 405 and 406 of the preformed sections 305a,b may include applying thermal energy to a bonding material 503 that is disposed between the bonding areas 405 and 406 of the preformed sections 305a,b. In some embodiments, no additional bonding material may be used (e.g., only glue or solvent may be used). Thermal energy may be applied to the bonding areas 405 and 406 of the preformed sections 305a,b by heating the bonding areas 405 and 406 with electric or gas heating elements. In some embodiments, infrared or microwave radiation may be used to apply thermal energy. In some embodiments, thermal energy may be applied to the bonding areas 405 and 406 by a hot plate (e.g., hot plate 709 shown in FIG. 7b) such that a thin surface layer of the bonding areas 405 and 406 of one or more may be in a molten form. A molding bonding temperature approximately in a range of 120 to 180 degrees Celsius may be maintained at the bonding areas 405 and 406 inside the bonding mold 501 for a time approximately in a range of 90 to 180 seconds. Other temperatures and times may also be used. The times and temperatures may be dependent on the type of plastic used in the preformed sections 305a,b and/or the type of bonding material 503 used to bind the two preformed sections 305a,b. The times and temperatures may also depend on other properties (e.g., thickness of preformed sections 305a,b, etc.).

At 1107, the bonding mold 501 may be closed with the preformed sections 305a,b inside (e.g., see FIG. 7). In some embodiments, a vacuum may be applied to the preformed sections 305a,b to hold the preformed sections 305a,b in the bonding mold 501. Vacuum conduits 707,708 may allow a vacuum to be formed in the bonding mold's vacuum chambers (e.g., vacuum chamber 705) to hold the preformed sections 305a,b to the bonding mold 501.

At 1108, the bonding mold 501 may be secured (e.g., clamped or pressed together). In some embodiments, the bonding mold 501 may be pressed together by a compression molding machine (e.g., see FIG. 7a). For example, plates 1201a,b of the compression molding machine may engage to hold the two halves 751a,b of the bonding mold 501 together. In some embodiments, the bonding mold 501 may be clamped closed. The clamps may pull the two halves 751a,b together, for example, using internal threads or hydraulics. Other clamping methods are also contemplated.

At 1109, compressed air 701 (or another fluid) may be applied through the air intake valve 401, 411, or 450 to the preformed sections 305a,b in the bonding mold 501. For example, compressed air 701 may be applied through the air nozzle 703 to the air intake valve 401, 411, or 450 formed in a preformed section 305b to fill a cavity 601 formed between the preformed sections 305a,b. As the air nozzle 703 is inserted into the air intake valve 401, 411, or 450 and/or engages the air intake valve 401, 411, or 450, a valve sleeve or a housing on the air intake valve 401, 411, or 450 (e.g., see valve sleeve 403 in FIG. 4b or housing 413 in FIG. 4f) may expand to allow the air intake valve 401, 411, or 450 to expand and open. The compressed air 701 may provide internal pressure to keep the preformed sections 305a,b shaped while in the bonding mold 501.

At 1110, if the tire was at least partially inflated with air, the air pressure may be released (e.g., after the preformed sections 305a,b are securely bonded). The air pressure may be released after the tire 101 has cooled (and, for example, the bonding material is secured). In some embodiments, the air pressure may be released after the thermal energy has been applied, but before the tire 101 has cooled. In some embodiments, the air pressure may be released as the thermal energy is being applied. In some embodiments, (e.g., with thermoplastic tires) thermal energy may only be applied to the bonding areas 405 and 406 before the bonding mold 501 is closed.

At 1111, bonding molds 501 may be separated (e.g., may be unclamped or released from pressing) and the formed tire 101 may be removed (e.g., see FIG. 8) from the mold. In some embodiments, tire 101 may have an outer diameter approximately in a range of 100 mm-150 mm, an inner diameter approximately in a range of 30 mm-50 mm, a width approximately in a range of 60 mm-100 mm, and a thickness approximately in a range of 2 mm-5 mm. Other sizes are also possible. For example, FIG. 9a illustrates a cross section of tire 101 removed from the bonding mold 501.

At 1112, the fixing lugs 301 and, for example, excessive flashings of the tire (if any) may be removed from the tire. For example, fixing lugs and excessive flashings may be removed by a razor. FIG. 9b illustrates an embodiment of a tire 803 prior to the fixing lugs 301 being removed. FIG. 9c illustrates an embodiment of the tire 805 with fixing lugs removed.

Embodiments of a subset or all (and portions or all) of the above may be implemented by program instructions stored in a memory medium or carrier medium and executed by a processor (e.g., on a controller coupled to an assembly line for the molded tires 101). A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of forming a tire, comprising:
forming at least two preformed sections of the tire;
placing the at least two preformed sections into a bonding mold, wherein the preformed sections at least partially contact each other in the bonding mold; and
applying thermal energy to the at least two preformed sections.

2. The method of claim 1, wherein forming the at least two preformed sections further comprises forming an air intake valve in at least one of the preformed sections.

3. The method of claim 2, wherein a portion of the air intake valve is formed in one of the at least two preformed sections and another portion of the air intake valve is formed in at least one other of the at least two preformed sections, wherein the complete air intake valve is formed when the at least two preformed sections are placed together in alignment.

4. The method of claim 2, further comprising placing a valve sleeve onto the air intake valve.

5. The method of claim 1, wherein forming the at least two preformed sections further comprises forming a housing for an air intake valve in at least one of the preformed sections.

6. The method of claim 5, further comprising inserting an air intake valve into the housing.

7. The method of claim 1, further comprising applying a surface treatment to a bonding area between the at least two preformed sections.

8. The method of claim 1, further comprising applying curable glue or a solvent to the at least two preformed sections.

9. The method of claim 1, further comprising placing uncured rubber pieces on a bonding area between the two at least two preformed sections.

10. The method of claim 9, wherein applying thermal energy to the at least two preformed sections comprises applying thermal energy to the uncured rubber pieces.

11. The method of claim 1, wherein forming the at least two preformed sections further comprises forming an air intake valve, and wherein the method further comprises applying compressed air through the air intake valve into a cavity formed between the at least two preformed sections when the preformed sections are placed in the bonding mold.

12. The method of claim 11, further comprising releasing the air pressure after applying the thermal energy.

13. The method of claim 1, wherein the at least two preformed sections comprise fixing lugs formed thereon.

14. The method of claim 13, wherein placing the at least two preformed sections into the bonding mold comprises aligning the fixing lugs with corresponding features in the bonding mold.

15. The method of claim 1, wherein the preformed sections are made of a thermoset rubber material.

16. The method of claim 1, wherein the at least two preformed sections are formed by compression molding, transfer molding, or injection molding.

17. The method of claim 1, further comprising closing the bonding mold with the preformed sections inside.

18. The method of claim 17, further comprising securing the bonding mold with the preformed sections inside; wherein securing the bonding mold comprises pressing or clamping the bonding mold closed.

19. The method of claim 18, further comprising
unsecuring the bonding mold; and
releasing the tire from the bonding mold after unsecuring the bonding mold.

20. The method of claim 19,
wherein the at least two preformed sections comprise fixing lugs formed thereon;
wherein placing the at least two preformed sections into the bonding mold comprises aligning the fixing lugs with corresponding features in the bonding mold;
wherein the method further comprises removing the fixing lugs after the tire is released from the bonding mold.

21. A method of forming a tire, comprising:
forming at least two preformed sections of the tire, wherein at least one of the preformed sections includes at least one fixing lug formed thereon;
placing the preformed sections into a bonding mold, wherein the at least one of the preformed sections are aligned in the bonding mold by aligning the at least one fixing lug with at least one corresponding feature in the bonding mold;
applying thermal energy to the preformed sections in the bonding mold to form the tire;
closing the bonding molds;
applying compressed air into a cavity defined by the preformed sections disposed in the bonding mold;
removing at least a portion of the air from the cavity; and
removing the tire from the bonding mold.

22. The method of claim 21, wherein the preformed sections are comprised of thermoplastic.

23. The method of claim 21, further comprising removing the fixing lugs.

24. The method of claim 21, wherein forming the at least two preformed sections further comprises forming an air intake valve in at least one of the preformed sections.

25. The method of claim 24, further comprising placing a valve sleeve onto the air intake valve.

26. The method of claim 21, further comprising placing an air intake valve into a housing formed in at least one of the preformed sections.

27. The method of claim 21, further comprising applying a surface treatment to the bonding areas of the preformed sections.

28. The method of claim 21, further comprising applying a curable glue or solvent to the preformed sections.

29. The method of claim 21, further comprising securing the bonding mold 501 closed.

30. The method of claim 21, further comprising forming an air intake valve in the at least two preformed sections, wherein a portion of the air intake valve is formed in one of the at least two preformed sections and another portion of the air intake valve is formed in at least one other of the at least two preformed sections, wherein the complete air intake valve is formed when the at least two preformed sections are placed together in alignment.

31. The method of claim 21, wherein forming the at least two preformed sections further comprises forming a housing for an air intake valve in at least one of the preformed sections.
